(19) United States
(12) Patent Application Publication
(10) Pub. No.: US 2017/0072345 A1
(43) Pub. Date: Mar. 16, 2017

(54) METHOD AND APPARATUS FOR CLEANING A ROTATING BELT SIEVE

(71) Applicant: GENERAL ELECTRIC COMPANY, Schenectady, NY (US)

(72) Inventors: Wajahat Hussain SYED, Burlington, ON (CA); James John ROYSTON, Burlington, ON (CA)

(21) Appl. No.: 15/122,935

(22) PCT Filed: Mar. 20, 2014
(86) PCT No.: PCT/US2014/031321

§ 371 Date: Sep. 1, 2016

(51) Int. Cl. B01D 33/50; C02F 1/00; B01D 33/04

(52) U.S. Cl. CPC B01D 33/50; B01D 33/04; C02F 1/001

(57) ABSTRACT

This specification describes methods and apparatus for cleaning a micro-sieve medium such as a belt in a rotating belt sieve. In one method, water is mixed with air supplied to an air knife blowing against a micro-sieve medium. The water may provide droplets of water in air contacting the micro-sieve medium although the volumetric flow rate is still primarily produced by a gas flow. In another method, a cleaning agent is supplied to a micro-sieve medium while the micro-sieve medium is installed in a filtration unit, and preferably while the micro-sieve medium is in use filtering water. The cleaning chemical may be applied through a liquid sprayer, but is preferably applied through an air knife. In another method, a cleaning agent is supplied to a micro-sieve medium while the micro-sieve medium is not in use, and preferably while it is removed for soaking in a separate tank.

### FIELD

This disclosure relates generally to methods and systems for treating wastewater including primary treatment and treatment using a micro-sieve such as a rotating belt sieve.

### BACKGROUND

The following background discussion is not an admission that any information or documents described below are citable as prior art or part of the common general knowledge of a person skilled in the field.

In a conventional municipal sewage plant using an activated sludge process, the sewage passes sequentially through pre-treatment, primary treatment and secondary treatment. In pre-treatment, large solids and grit are removed, for example by a course (i.e. 3 mm) screen or a hydrocyclone. In primary treatment, some of the suspended solids and organic contaminants, usually measured as biological oxygen demand (BOD) or chemical oxygen demand (COD), are removed. Primary treatment is a solids separation process, typically provided by sedimentation in a clarifier. In secondary treatment, remaining organic contaminants are degraded by various forms of biological treatment. In the activated sludge process, the secondary treatment also involves solid-liquid separation of the biologically active wastewater (which may be referred to as mixed liquor) to produce activated sludge. Part of the activated sludge is returned to the biological process tank and part is wasted. Primary sludge and waste activated sludge may be further treated in an anaerobic digester, by dewatering and drying, or by a combination of methods.

Primary treatment is defined by the EU Urban Waste Water Directive (Council Directive, 1991) as physical and/or chemical treatment to remove 20% or more of BOD5, and 50% or more of total solids (TS), from incoming wastewater. Typically, the incoming wastewater has not been biologically treated before primary treatment.

US Publication Number US 2013/0134089 describes a wastewater treatment process that uses enhanced primary treatment to remove suspended solids from raw wastewater. Primary sludge is screened then treated in a fermenter and an anaerobic digester. Primary effluent is treated by biological nutrient removal. The enhanced primary treatment removes about 60-70% of suspended solids (SS) and 30-40% of the COD from pre-treated influent wastewater. Enhanced primary treatment may be provided by a lamella clarifer or by a micro sieve, for example a micro-sieve made by Salsnes Filter AS of Norway.

A micro sieve as made by Salsnes Filter provides filtration by way of a rotating belt of filter fabric (alternatively called filtermesh). Units of this type are often called a rotating belt sieve, rotating belt filter or rotating belt screen. These filters are available commercially and also described in International Publications WO 94/26387, WO 01/56681, WO 2009/091260 and WO 2012/105847. Similar rotating belt filters are described in International Publication Numbers WO 2012/145712 and WO 2012/145763.

In brief, a filter housing is divided by a fabric belt arranged in an endless loop around rollers so as to divide the housing into an inlet chamber and an outlet chamber. A part of the belt extends out of these chambers and over a sludge hopper. Wastewater enters the inlet chamber and is filtered while flowing through the belt to the outlet chamber. Filtered primary effluent is withdrawn from the outlet chamber. Solids collect on the top of the belt and are transported by the rotation of the belt to the sludge hopper. As the belt turns over a roller, solids drop off of the belt into the sludge hopper. Additional solids are removed by an air knife which continuously blows compressed air through the bottom of the belt over the hopper. Twice a day, liquid spray nozzles spray hot water through the belt to remove grease and oil from the belt. Optionally, a screw press integrated into the sludge hopper dewaters the solids to produce a cake and a sludge liquid fraction. In some cases, flocculating chemicals are added to the influent wastewater.

A thesis entitled “Assessment of theoretical and practical aspects of the Salsnes filtration unit”, submitted by Anders Soraunet to the Norwegian Institute of Science and Technology, contains a summary of various reports by others, a theoretical discussion of filtration through a fabric belt, and some experimental testing of filtration through samples of belt fabric. The mesh size of the belt recommended for primary treatment of municipal wastewater is between 210 and 850 microns. 350 microns is the most common size. Considering that most solids in municipal wastewater are below this size, it was proposed that cake filtration (alternatively call matt filtration) and possibly pore blocking or pore constriction are part of the filtration mechanism. The continuous compressed air cleaning is believed to be advantageous because it both cleans the belt and helps to provide a dry sludge.

### INTRODUCTION

The following discussion is intended to introduce the reader to the detailed description to follow and not to limit or define any claimed invention.

This specification describes various methods for cleaning a micro-sieve medium such as a belt in a rotating belt sieve. The methods can be used alone or in combinations of two or more methods. This specification also describes cleaning apparatus suitable for implementing one or more of the methods.

In one apparatus, an air knife has a liquid inlet. The liquid inlet is preferably in communication with a compressed air supply line or an air distribution plenum of the air knife. When the liquid inlet is in communication with the air distribution plenum, a discharge port of the liquid inlet is preferably located near the compressed air inlet. In use, compressed air and a liquid are supplied to the air knife. The compressed air may vaporize or atomize the liquid but in any event and carries the liquid as a vapor or droplets through and out of the air knife. Optionally, a gas other than air may be used.

In one method, water is mixed with air supplied to an air knife blowing against or through a micro-sieve medium. The water may increase the humidity of air contacting the micro-sieve medium but preferably also provides droplets of water in the air, for example a mist, contacting the micro-sieve medium. When droplets of water are used the volumetric flow rate is still primarily produced by a gas flow. The air is preferably applied to the micro-sieve medium substantially continuously while the micro-sieve medium is in use, and preferably at a pressure of at least 0.3 bar and a temperature of 60-70 degrees C. or more. The addition of water may help prevent fouling by dried solids of the air knife, the micro-sieve medium, or both.

In another method, a cleaning agent other than, or in addition to, water is applied to a micro-sieve medium. The cleaning agent may be applied while the micro-sieve medium is installed in a filtration unit, preferably while the micro-sieve medium is in use filtering water. The cleaning agent may comprise one or more of an acid, an oxidant and a surfactant, typically in aqueous solution but optionally as a gas. The cleaning agent may be applied through a liquid sprayer, but is preferably applied through an air knife. The cleaning agent is preferably supplied at least once per week of use of the micro-sieve medium. The cleaning agent may be supplied for a short period of time, for example one hour or less, in each application.

In another method, a cleaning agent is applied to a micro-sieve medium less frequently than in the method above, but for a longer period of time in each application. Preferably, the micro-sieve medium is not in use while the cleaning agent is applied in this method. The micro-sieve may remain installed in a filtration unit, but preferably it is removed for soaking in the cleaning agent in a separate tank. The cleaning agent may be applied for two hours or more in each application. Preferably, the micro-sieve medium is put in use for at least one month between applications of the cleaning agent by this method.

The methods described above may be used in particular with a micro-sieve medium having a mesh size of 350 microns or less, preferably 150 microns or less. The micro-sieve medium may be used, for example, for primary treatment of municipal or other wastewater. Two or more of the methods described above may be combined. In a most preferred process, all three of the cleaning methods described above are used.

### BRIEF DESCRIPTION OF THE FIGURES

FIG. 1 is a schematic cross section of a rotating belt sieve filtration unit.

FIG. 2 is a side view of an air knife of the filtration unit of FIG. 1.

FIG. 3 is a cross-section of the air knife of FIG. 2.

### DETAILED DESCRIPTION

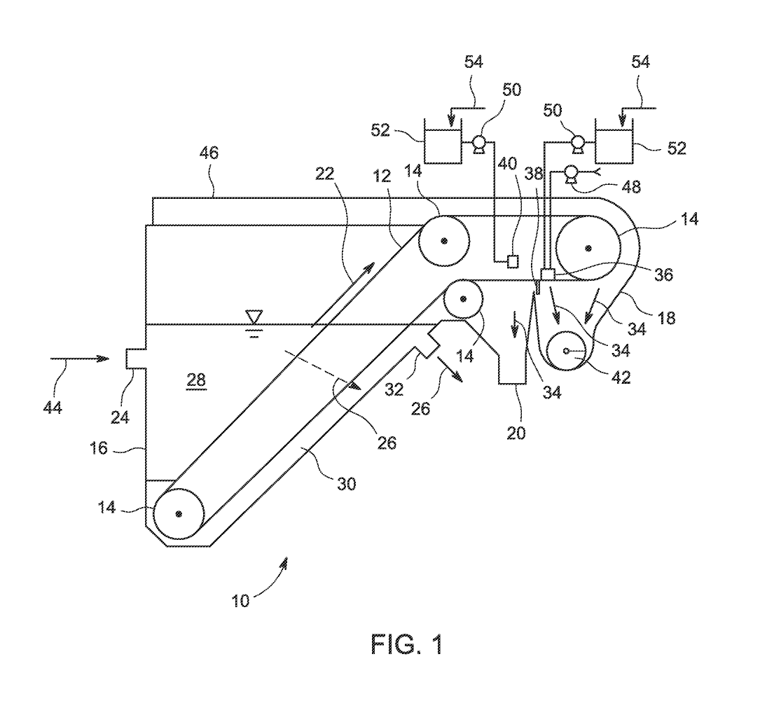

FIG. 1 shows a micro-sieve filtration unit, in particular a rotating belt sieve (RBS) 10. The RBS 10 has a looped endless belt 12 arranged to rotate in the rotating direction 22 indicated over various rollers 14. The belt 12 is driven by a motor and gear mechanism (not shown) which engages with teeth on the edges of the belt 12. Part of the belt 12 passes diagonally through a housing 16 and divides the housing 16 into an inlet chamber 28 and an outlet chamber 30. Another part of the belt 12 extends horizontally or diagonally over a sludge hopper 18 and a gutter 20.

The belt 12 comprises a micro-sieving medium. This medium is typically a woven or non-woven fabric. However, other materials such as steel mesh may also be used. The belt 12 may be made, for example, of a woven fabric or web made of filaments or yarns. The filaments or yarns may be made of polyester or other thermoplastic materials suitable for being spun into fibers.

While the RBS 10 is in use for filtration, wastewater 44 flows into the tank 16 through an inlet 24 in communication with the inlet chamber 28. Filtered water 26 passes through the belt 12, and leaves the RBS 10 through an outlet 32 in communication with the outlet chamber 30. Retained solids collect on the top of the belt 12 and are transported by the rotation of the belt 12 to the sludge hopper 18. As the belt 12 turns over a roller 14 above the sludge hopper 18, retained solids 34 drop off of the belt 12 into the sludge hopper 18. Additional retained solids 34 are blown off of the belt 12 and into the sludge hopper 18 by an air knife 36. A scraper 38 holds the belt 12 against the bottom of the air knife 36. The air knife 36 blows compressed air through the belt 12 continuously while the belt 12 is rotating. Periodically, for example twice a day, liquid spray nozzles 40 spray hot water through the belt 12 to remove less easily removed retained solids 34, for example grease and oil, from the belt 12. The sprayed water and these retained solids 34 are collected in the gutter 20. A screw 42 removes retained solids 34 from the sludge hopper 18. Optionally, the screw 42 may be part of a screw press integrated into the sludge hopper 18 which dewaters the retained solids 34 to produce a cake and a sludge liquid fraction. Optionally, flocculating chemicals may be added to the influent wastewater or the inlet chamber 28. A cover 46 allows gasses emitted from the RBS 10 to be collected and optionally treated before they are released to the atmosphere.

The air knife 36 is, generally speaking, a pipe or other body defining a plenum extending across the width of the belt 12. Compressed air is fed into the plenum through one or more inlets and exits the plenum through one more slots or other openings arranged to blow air against the belt 12. Preferably, the air knife 36 blows air downwards against the inside of the belt 12 and through a portion of the belt 12 located over the sludge hopper 18. The air is supplied by a compressor 48 drawing air from the atmosphere and connected to the air knife 36. The air may be heated. For some cleaning methods, the air knife 36 is also connected to a liquid pump 50 connected to a tank 52. The tank 52 may be filled with water 54 which may be ordinary potable water or water with one or more cleaning agents in solution. In another option, not shown, the air knife 36 may be connected to an ozone generator or other supply of a gaseous cleaning agent.

The liquid spray nozzles 40 may also be in the form of a pipe extending across the width of the belt 12, or a series of individual nozzles attached to a pipe extending across the width of the belt 12. The liquid spray nozzles 40 preferably spray water downwards against the inside of the belt 12 and through a portion of the belt 12 located over the gutter 20. The water may be heated. Water and retained solids 34 collected in the gutter 20 are preferably sent back to the inlet 24 of the RBS 10. The liquid spay nozzles are supplied by another liquid pump 50 connected to another tank 52. This tank 52 may also be filled with water 54, which may be ordinary potable water or water with one or more cleaning agents in solution.

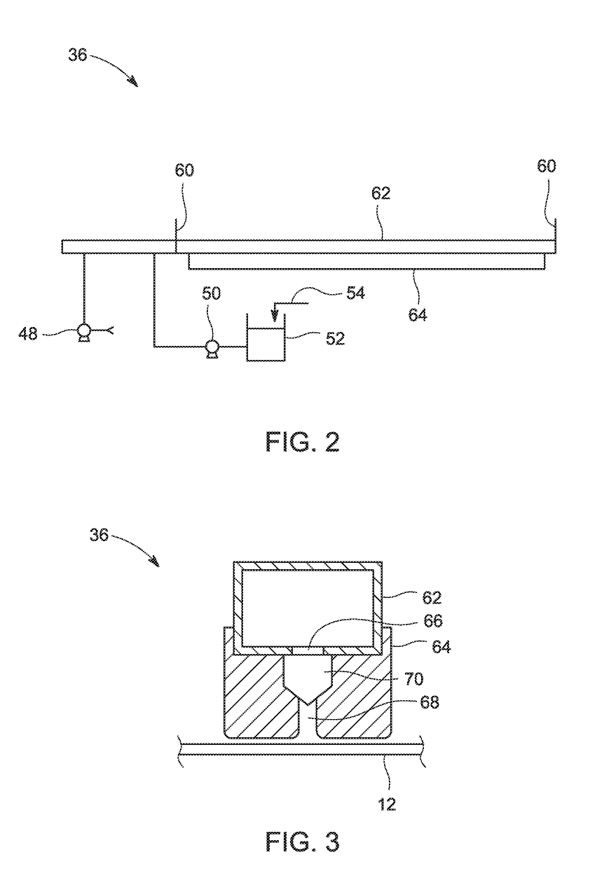

FIGS. 2 and 3 show additional features of the air knife 36. The air knife 36 has brackets 60 for attaching it to a frame (not shown) holding the rollers 12 of the RBS 10. The air knife 36 has a supply pipe 62 and a shoe 64, although the air knife may optionally be made in one piece. Either or both of the air supply pipe 62 or the shoe 64 may define an air distribution plenum. The shoe 64 is preferably made of a low friction polymer since it bears against the belt 12. Holes 66 in the supply pipe 62 pass air into holes 70 in the shoe 64. These holes 70 open into a slot 68 which extends across the width of the active filter area of the belt 12. Compressed air is delivered to the supply pipe 62 upstream of water 54. In this way, water 54 becomes entrained in the flow of compressed air travelling through slot 68. Preferably, the water 54 is entrained as droplets in a flow that is more gas than liquid, i.e. the volumetric flow rate of fluids through the slot 68 still being provided primarily by air. For example, a mist may be produced. As shown, the water 54 and compressed air have separate inlets to the supply pipe 62. Alternatively, the water 54 may be injected into the compressed air line leading to the supply pipe 62.

The belt 12 or air knife 36 or both may become fouled or plugged over time. While fouling of the belt 12 is the most common concern, the inventors have observed that some solids can also enter the slot 68 of the air knife. Blowing compressed air though the slot 68 dries these solids and forms a crust in the slot 68. This results in uneven air flow through the belt 12 which in turn can lead to fouling in the belt itself. In various cleaning methods to be described below, water or one or more cleaning agents are ejected into the air knife 36 or otherwise onto the belt 12 to clean the air knife 36, the belt 12, or both.

In one cleaning method, water and optionally one or more cleaning agents are added to the compressed air flowing through the air knife 36. This water is preferably added for at least 50% of the time, and optionally for between 80% to all of the time, that the compressed air flows through the air knife 36. The compressed air preferably flows through the air knife essentially continuously while the RBS 10 is in operation. Accordingly, the air and water are preferably provided to the belt 12 together for 50% or more or 80% or more of the time that the RBS 10 is in operation. Optionally, the water might be added in pulses or otherwise intermittently.

Injecting water into the compressed air line or the supply pipe 62 creates a vapor or, preferably, a spray or mist that helps removes solids from the slot 68 of the air knife 36, from the outer surface of the belt 12, and from the pores of the belt 12. Without intending to be limited by theory, the water helps prevent solids from drying in the slot 68 and inside the pores of the air knife 36 which is helpful because dried solids resist being removed by compressed air alone. Further, liquid droplets if present may provide a physical force of impact that enhances the effect of the compressed air flow. The air-water mist may also make the retained solids 34 wetter and heavier, either of which may encourage the retained solids 34 to drop into the sludge hopper 18 instead of travelling past the scraper 38 to the outlet chamber 30.

Optionally, the amount of water added to the air knife 36 may be from 0.1 liter per minute to 5 liter per minute. The flow rate of the water may be between 0.01% and 5% or between 0.01% and 1% of the flow rate of the wastewater entering the RBS 10. The compressed air is preferably supplied to the air knife 36 at a pressure of at least 0.3 bar, preferably at least 0.5 bar. While the water helps avoid drying solids in the air knife 36 or belt 12, it is also possible that water droplets ejected with compressed air may improve the mechanical cleaning effect, or effective pressure, of the air knife 36 and allow for a reduction in air flow or pressure, relative to ordinarily specified flow or pressure, for the same cleaning effect. In an alternative method, steam, alone or in combination with air, could be ejected through the air knife 36 to clean the air knife 36 or belt 12.

In a second cleaning method, a cleaning agent is applied to the belt periodically. The cleaning agent includes one or more substances other than water although the cleaning agent may be applied in an aqueous form. The cleaning agent may be applied, for example, as a gas (for example ozone) or liquid mixture through the air knife 36, through the liquid spray nozzles 40, or by removing the belt 12 to a soak tank or other treatment area. In a third cleaning method, a cleaning agent is also applied to the belt but less frequently, and for a longer period of time per application, relative to the second method. Preferably, the second and third methods are used together rather than as alternatives of each other. Since removing the belt 12 disrupts the filtration process but allows soaking the belt 12 in a chemical agent, removing the belt 12 is preferred in the third method but not in the second method.

In the second method, the cleaning agent may be applied while the belt 12 is installed in the RBS 10, preferably while the RBS 10 is in use filtering water. The cleaning agent may be applied through the liquid spray nozzles 40, but is preferably applied through the air knife 36. The cleaning agent is preferably supplied at least once every two weeks, or once per week, of use of the belt 12, optionally up to once per day or more. The cleaning agent is preferably supplied for a short period of time in each application. For example, the period of time may be one hour or less, or 20 minutes or less, or at least 1 minute, or at least 5 minutes. The cleaning agent may be applied in the second method according to a predetermined frequency or schedule or in response to a measurement related to the resistance of the belt 12 such as height of water upstream of the belt.

In the third method, the cleaning agent is applied to the belt 12 less frequently than in the second method, but for a longer period of time in each application. Preferably, the RBS 10 is not in use while the cleaning agent is applied in this method. The belt 12 may remain installed in the RBS 10, but preferably it is removed for soaking in the cleaning agent in a separate tank. The cleaning agent may be applied for 15 minutes or more or two hours or more, or for 12 hours or less, in each application, for example between 4 and 8 hours. Preferably, the belt 12 is put in use for at least one month, for example between 4 and 9 months, between applications of the cleaning agent by this method. The cleaning agent may be applied in the third method according to a predetermined frequency or schedule or in response to a measurement related to the resistance of the belt 12 such as height of water upstream of the belt.

In the second and third methods described above, the chemical agent may include one or more of an oxidant, an acid and a surfactant. Suitable oxidants include sodium hypochlorite, ozone and peroxide. Suitable acids include citric acid. A surfactant can be used alone or mixed with an oxidant, and possible with an acid. An oxidant and acid are typically not used together. The concentration of the chemical agent, for example sodium hypochlorite, citric acid or a surfactant, may be from 0.5 to 10,000 ppm. Ozone is preferably used at a rate which causes it to be entirely consumed oxidizing organic material on the belt 12 so as to minimize ozone emissions. However, since all gases emitted from the RBS 10 may be captured, the exhaust gas can also be treated to destroy remaining ozone if necessary.

Periodically cleaning the belt 12, with water mist or one or more chemical agents or by improved operation of the air knife, improves the throughput (or maximum hydraulic loading rate) of the RBS 10 which helps minimizing the chances of belt bypass or influent overflow. The cleaning procedures may also allow rotating the belt at a lower speed which can help build the dynamic cake on the surface of the belt 12 for better suspended solids and organics removal. Alternatively, the cleaning procedures may allow operating with a smaller mesh size, for example 150 microns or less or 90 microns or less even with raw or only physically pre-treated sewage as the influent.

High solids and organics removal in primary treatment helps reduce the energy consumption and foot print of a secondary wastewater treatment process following the primary treatment and of the wastewater treatment plant as a whole. For example, a micro-sieve cleaned as described above may be used for primary treatment of raw sewage (possibly pre-treated) upstream of a membrane bioreactor (MBR). The primary sludge may be sent to anaerobic treatment directly or indirectly. Since anaerobic digestion uses less energy than an MBR per unit of COD or BOD consumed, energy consumption of the wastewater treatment plant is reduced. Other examples of wastewater treatment plants with a micro-sieve are described in U.S. application Ser. No. 13/686,160 filed on Nov. 27, 2012 and published as US Publication Number US 2013/0134089; international application number US2013/027411 filed on Feb. 22, 2013; and, international application number US2013/027403 filed on Feb. 22, 2013, which are all incorporated by reference. The cleaning device and method described herein may be used with the micro-sieve, and particularly a rotating belt sieve, in any process or method described in any of these applications. As in some of these applications, the micro-sieve can also be used treat activated sludge or other biologically treated sludge, in whole or mixed with raw sewage. Without intending to be limited by theory, operating with smaller belt sizes may improve the removal of very fine organic particles and thereby increase the energy efficiency of a wastewater treatment plant.

The methods and apparatus described herein may also be used to clean other micro-sieving media. A micro-sieve may also be called a micro-screen or micro-strainer. In general, a micro-sieve medium is in the form of a sheet with openings of size of 1000 microns of less measured as the smallest length of a square or rectangular opening, the diameter or a circular opening, or the diameter of a circle having the same area as an opening. In addition to rotating belt sieves, the methods and devices described herein may be used with a rotating disc filter, a rotating drum filter, or any other type of filter having a micro-sieve medium.

### Example

An RBS made by Salsnes was modified to allow water, in the form of a spray of droplets, to be added to its air knife generally as described above. Water was added at a rate of 1 liter per minute (lpm), which was 0.15% of the flow rate of the raw municipal sewage being treated. The loading rate on the belt was 230 m3/m2/h. The RBS was tested with 90, 150, 210 and 350 micron belts. Operation was sustainable even with the 90 and 150 micron belts.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. An apparatus comprising,
a) a micro-sieve medium; and
b) an air knife directed at the micro-sieve medium, wherein the air knife has a liquid inlet.

2. The apparatus in claim 1 wherein the air knife further comprises a compressed gas supply line and an air distribution plenum and the liquid inlet is in communication with the compressed gas supply line or the air distribution plenum of the air knife.

3. The apparatus of claim 1 wherein the air knife further comprises a compressed gas supply line and an air distribution plenum and the liquid inlet is in communication with the air distribution near the compressed air inlet.

4. The apparatus of claim 1 wherein the micro-sieve medium is a rotating belt.

5. The apparatus of claim 4 wherein the rotating belt is located within a rotating belt filter unit and an outlet chamber of the rotating belt filter unit is connected to a downstream secondary treatment section of a wastewater treatment plant.

6. The apparatus of claim 4 wherein the rotating belt is located within a rotating belt filter unit and a sludge hopper of the rotating belt filter unit is connected to an anaerobic digester.

7. A method of cleaning a micro-sieve medium comprising one or more of,
a) feeding a gas and water to an air knife directed at the micro-sieve medium;
b) applying a cleaning agent to the micro-sieve medium while the micro-sieve medium is installed in a filtration unit;
c) applying a cleaning agent to the micro-sieve medium after removing the micro-sieve medium from the filtration unit;
d) directing a mixture of gas and water droplets at the micro-sieve medium;
e) applying a cleaning agent to the micro-sieve medium at least once per two weeks for one hour or less; and,
f) applying a cleaning agent to the micro-sieve medium for 15 minutes or more or two hours or more with at least one month between applications.

8. The method of claim 7 comprising feeding a gas and water to an air knife directed at the micro-sieve medium or directing a mixture of gas and water droplets at the micro-sieve medium.

9. The method of claim 8 wherein the gas and water are directed at the micro-sieve medium for at least 50% of the time while the micro-sieve medium is in use.

10. The method of claim 8 comprising feeding a gas and water to an air knife directed at the micro-sieve medium wherein water is sprayed through or against the micro-sieve medium from the air knife in the form of droplets.

11. The method of claim 8 wherein the volume flow rate of the water is between 0.01% and 5% or between 0.01% and 1% of the volume flow rate of wastewater passing through the micro-sieve medium.

12. The method of claim 7 comprising supplying a cleaning agent to the micro-sieve medium while the micro-sieve medium is installed in a filtration unit.

13. The method of claim 12 wherein the cleaning agent is supplied to the micro-sieve medium while the micro-sieve medium is in use filtering water.

14. The method of claim 12 wherein the cleaning agent is applied through a liquid sprayer or an air knife.

15. The method of claim 12 wherein the cleaning agent is applied at least once per week for one hour or less.

16. The method of claim 7 comprising supplying a cleaning agent to the micro-sieve medium after removing the micro-sieve medium from the filtration unit.

17. The method of claim 16 wherein the cleaning agent is applied for two hours or more with at least one month between applications.

18. The method of claim 7 wherein the micro-sieve medium is a rotating belt.

19. The method of claim 7 wherein the micro-sieve medium has openings of 350 microns or less or 150 microns or less.

20. The method of claim 7 comprising passing municipal wastewater through the micro-sieve medium so as to provide primary treatment of the wastewater.
